(19) United States
(12) Patent Application Publication
(10) Pub. No.: US 2007/0265956 A1
(43) Pub. Date: Nov. 15, 2007

(54) Information broker for directing, customizing, exchanging, negotiating, trading and provisioning of information, goods and services in an information network

(76) Inventors: Kenneth Epstein, Fort Lauderdale, FL (US); Roberto Rafalowsky, North Bergen, NJ (US); Srinivasan Rao, Brooking, MA (US); Miguel Ramos, Plantation, FL (US); Elliot Kopstein, Fort Lauderdale, FL (US); P.G. Mohan Rao, Belmont, MA (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/827,828

(22) Filed: Jul. 13, 2007

Related U.S. Application Data
(62) Division of application No. 10/178,904, filed on Jun. 21, 2002.

(51) Int. Cl. G06Q 40/00

(52) U.S. Cl. 705/37

(57) ABSTRACT

An information broker for use in an information distribution system permits users to receive information based on authentication from a second source. The information broker includes a memory, a network interface, and a processing unit. The memory contains at least one device characteristic and one user characteristic corresponding to a user device and user, respectively. The broker receives a request for information from a first user device, authenticates the request, provides the requested information for authenticated requests, and based on the request, updates the at least one characteristic contained in the memory that corresponds to the first user device. The broker transmits an authorization request to a second user device and only provides the requested information to the first user device when authorized by the second device. The broker determines if the first user device is capable of receiving the requested information based on the device characteristic stored in memory.

### CROSS REFERENCE TO RELATED APPLICATIONS

This application is a division of co-pending U.S. patent application Ser. No. 10/178,904 filed Jun. 21, 2002, currently pending.

### BACKGROUND OF THE INVENTION

1. Field of the Invention

This invention relates to computer or non-computer based retrieval, storage and dissemination systems and methods, and, more particularly, pertains to an information broker for use in an information system for enabling providers, sellers, users and purchasers of information, goods and services to learn about each other and to consummate transactions in a secure manner.

2. Background Art

This invention is intended to offer a comprehensive and efficient way for information providers, users, and prospective purchasers (e.g. businesses or consumers, users) to intuitively receive information about available products and services which coincide with the interests and needs of the user and/or prospective purchasers. Until now, techniques for marketing and selling goods and services and distributing information to consumers have been limited to traditional “bricks and mortar” businesses on the one hand, and Internet or e-commerce techniques on the other. Problems attendant to each technique are readily known. “Bricks and mortar” businesses usually require the purchaser to be physically present at a retail location, or physically possess an item of marketing material, to consummate a transaction. E-commerce transactions are carried out over the Internet. Consequently, the purchaser is required to be online at the time of consummating the transaction. Information retrieval requires the consumer to review publications (e.g. newspaper, magazine) or to be online and look-up information on the Internet. In either event, the customer must make him or herself present at a particular location, be in possession of materials (e.g. catalog, newspaper) or be in communication electronically when the transaction is carried out.

Existing efforts to make consumers aware of the availability of information, goods or services also suffer from serious limitations. Creation of mailing lists, data mining, mass marketing and use of banners for advertising are standard procedure. Also, development of mobile devices has exploded in the past few years (i.e. pagers, cellular phones, PDAs). These devices have become more like personal computers due to the inclusion of browser capabilities therein. However, getting consumers to embrace these new developments has proven extremely difficult. Hence, the market for services based on such improvements has been disappointingly slow in developing.

Perhaps one reason for this phenomenon is the harsh realization experienced by consumers that, when it comes to information retrieval and purchasing goods or services, the Internet is just another avenue of ordering and delivery, but carries with it the risk of one's personal information being obtained by unwanted third parties. This has resulted in unwanted junk mail being received because products or services that the consumer showed interest in revealed to sellers the preferences of the consumer. Those sellers, being able to purchase information about consumers and their preferences, now bombard consumers with solicitations.

In addition, ordering online requires the purchaser to enter shipping and financial information separately for each purchase. Not only do the shipping and financial information pages on most websites now include distracting multimedia windows with flash animation, etc, but the customer specific, personal information must be entered over and over again for each successive transaction.

The amount of time spent, and the success realized, by consumers who shop on the Internet varies widely among individuals and businesses. However, by far the vast majority of products and services purchased in today's economy are purchased through traditional, non-Internet, channels. One reason for this is that too many people view the Internet and the World Wide Web as a disorganized space. Many computer users wander from site to site, spending substantial amounts of time, hoping to find content, products and/or services that are of interest. One reason that the task of navigating the Internet, and specifically the World Wide Web portion of the Internet, seems and is daunting is that there is no way to pull content from various locations or sites and organize it in a manner that is meaningful to the individual user. While some sites may be devoted to the task of organizing information from a variety of locations, the management or organization is static and hence the same for all users. The needs and preferences of individual users are not taken into account. Consequently, the content of such sites is displayed similarly to all users.

Another wide spread problem with the state of the art is that, in order to learn about an available product or service or information of interest in real time or an otherwise expeditious manner with respect to time sensitive information, the prospective purchaser must be online at all times during which the prospective purchaser is ready and willing to perceive the information. This requires an Internet connection during all such times, which is, for obvious reasons, cumbersome, impractical and undesirable.

A still further shortcoming in present techniques of advertising is the method by which a class of potential customers is targeted by an advertiser. For example, television commercials are more often than not presented to either an empty room or to a disinterested viewer. Also, advertising on the World Wide Web rarely, if ever, achieves the advertiser's desired impact and penetration because Internet users have grown accustomed to “tuning out” information which appears on a screen display which is not related to the information presently sought by the user.

Targeted marketing of individual users on the Internet is not a new concept. Many companies attempt to obtain information about users and the user's e-mail address so that they can identify a particular user with potential interest in their products and services and then direct market those particular users with an e-mail campaign at some time in the future. Unfortunately, even some users who might be interested in receiving information about a particular company are reluctant to provide any information to businesses over the Internet because they cannot be sure the information will not be accessible to third parties. Problems of fraud have become prevalent where user's identities were stolen by unscrupulous Internet users. Consequently, many users are reluctant to provide information about themselves to anyone over the Internet.

Efforts have been directed toward online commerce, and are discussed below:
U.S. Pat. No. 6,253,069 to Mankovitz is directed to a method and apparatus for providing information in response to telephone requests. The invention uses the location of the telephone and the phone number in combination with a user's entry on the keypad to accept user requests for goods, services, information, etc. and to enter contests.
U.S. Pat. No. 6,084,628 to Sawyer is directed to a system and method for providing targeted advertisements during video telephone calls. Sawyer provides a videoconference system which superimposes targeted advertisements on video displays during video telephone calls.
U.S. Pat. No. 6,119,098 to Guyot, et al. is directed to a system and method for targeting and distributing advertisements across a network. Guyot provides a targeted advertisement system which stores user preferences. A user device retrieves and stores targeted advertisements to present to the user, and periodically obtains additional targeted advertisements when the targeted advertisement inventory on the user's device runs low.
U.S. Pat. No. 6,055,510 to Henrick, et al. is directed to a method for providing targeted marketing over a computer network such as the Internet. Henrick provides a system which determines and stores identity data corresponding to a computer user. The system sends electronic mail to the user's device with embedded links to special offers. Identification information of the user is sent to an advertiser if the user selects a link. The system tracks user link selections and advertisers are billed by the number of e-mails sent to computer users and the number of responses generated therefrom.
U.S. Pat. No. 6,026,374 to Chess is directed to a system and method for generating and providing summary information of products to potential buyers without disclosing the entire contents of the information. Chess provides a system which includes a third party device which summarizes information passing between a buyer and a seller. The buyer trusts that the information is accurate while the seller trusts that the summarizing mechanism will not disclose the entire description of the product to the buyer. In this case the products are typically information-based products.
U.S. Pat. No. 6,014,638 to Burge is directed to a system for customizing information presented on computer displays based on user preferences. The system described in Burge records web browsing choices made by a user and provides customized shopping displays based on the user preferences.
U.S. Pat. No. 6,009,410 to LeMole, et al. is directed to a method and system for presenting customized advertising to an Internet user. LeMole features the creation of a composite browser page and transmission of the composite browser page to a client machine. Creation of the composite browser page is based on a stored user profile and at least one element of the page is based on previously visited pages as reported by the client machine to a central server.
U.S. Pat. No. 5,915,243 to Smolen is directed to a method and apparatus for offering promotions to a consumer based on the consumer's information profile. Smolen teaches that a user interacts with a set top box to answer questions and create a profile. The questions can be based on an existing profile. Promotions are offered to the user via the set top box based on the profile.
U.S. Pat. No. 6,233,609 to Mittal is directed to a system for selling products and services over the Internet. Mittal teaches that a client machine receives a graphical user interface (“GUI”) from a server which allows the user to configure a desired product from various configuration options. The user can view the configurations an initiate ordering. The GUI can be a browser plug-in.
U.S. Pat. No. 6,219,696 to Wynblatt, et al. is directed to a system for providing targeted information derived from the Internet to mobile devices. Wynblatt teaches that a mobile terminal receives short distance broadcast messages containing URL information corresponding to billboard or other fixed advertising devices. The mobile terminal stores the URLs for later recall and access.
U.S. Pat. No. 6,236,795 to Boe, et al. is directed to a targeted marketing system and method. In accordance with Boe a user interacts with a web browser to answer questions. The system shows a user how he fits into his peer group based on his responses. The user can also answer hypothetical questions to create a hypothetical profile derived from the actual profile to see what certain changes in the user's answers would do to his placement in the peer groups. The user is also presented with targeted advertisements during user's interaction with the system.
U.S. Pat. No. 5,815,665 to Tepper, et al. is directed to an online purchasing and billing brokering service. In accordance with Tepper, service providers billing information into a brokering computer based on authenticated use by a user of the service provider's system. The customer has access to the broker machine to see bills. A system constructed in accordance with the described embodiment makes use of the Microsoft Network (AMSN). The brokering site is also used to authenticate user requests to the service provider.
U.S. Pat. No. 5,873,068 to Beaumont, et al. is directed to a display-based marketing message control system which uses the public switched telephone network. Beaumont's system stores information about connected devices and stores information about a user. The system formats and sends marketing messages to unattended display devices using the public switch telephone network at predetermined times and without ringing the device. The system tracks responses from the devices, presumably initiating by a user, and creates marketing information therefrom. Users can update their profile. Also, the system allows targeted messages to be sent to a consumer or a group of consumers sharing a common characteristic.

There are no known systems which permit prospective consumers and purchasers of goods and/or services to learn information on desired topics through a variety of communications means and through a secure, trusted, interface, which amounts to an intuitive virtual personal assistant, pertaining to a particular customer's preferences. Nor are there any known systems which posses the ability to learn of a particular user's desires and preferences in regard to information, goods and/or services, and to seek out information about such content and relay that information to the user based upon discrimination criteria obtained and/or learned from or about the user.

### BRIEF DESCRIPTION OF THE DRAWINGS

With respect to the above described description, it is to be realized that the optimum dimensional relationships for the parts of the invention, to include variation in size, materials, shape, form, function and manner of operation, assembly and use are deemed apparent and obvious to those skilled in the art, and all the equivalent relationships to those illustrated in the drawings and described in the specifications herein are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents are considered to fall within the scope of the invention.

FIG. 1 is a generalized representation of a system for use in connection with the present invention.

FIG. 2 is a block diagram indicating the features of the trusted agent.

FIGS. 3A-3C are a schematic representation of a customer profile database for use with the instant invention.

FIGS. 4A-4B are a schematic representation of a promotions database for use with the instant invention.

FIG. 5 is a schematic representation of an information node tree which illustrates representative information categories for implementation on and in connection with customer devices.

FIG. 6 is a block diagram of a typical supplier-trusted agent relationship.

FIG. 7 is a schematic representation of an exemplary communications scheme between the trusted agent and the customer.

FIG. 8 is a schematic representation of another version of an exemplary communication protocol between the trusted agent and the customer.

FIG. 9 is a process diagram showing some of the features of the trusted agent.

FIG. 10 is a schematic representation of additional features of the trusted agent.

FIG. 11 is a schematic representation of a network configuration for the instant invention.

FIG. 12 is a flow diagram representative of the subscription process carried out by customers who wish to subscribe to the system.

FIG. 13 is a schematic diagram of a typical enrollment procedure.

FIG. 14 is a depiction of exemplary customer database information categories.

FIG. 15 is a schematic representation of the process of communications between the broker agent, the customer agent and the user/customer.

FIG. 16 is a diagrammatic representation of customized messages created by the customer agent and sent to the customer.

FIG. 17 is a diagrammatic representation of a trusted/broker agent.

FIG. 18 is a schematic representation of a step of providing notification to data providers that information relative to specific topics is being sought.

FIG. 19 is a schematic representation of an interface module (trusted/broker agent) which carries out a step of receiving and providing information from/to data providers to the user agent through the trusted agent.

FIG. 20 is a schematic representation of the trusted agent architecture.

FIG. 21 is a schematic representation of the user agent architecture.

FIG. 22 is a block diagram that shows the automated action taken by the trusted agent as well as the automated actions taken by the user agent.

FIG. 23 shows the trusted agent processing steps.

FIG. 24 is a schematic representation of the communication flow paths between the supplier agents and the customer agents, through the broker agent.

### DETAILED DESCRIPTION OF THE INVENTION

The instant invention is drawn to computer implemented systems which behave as intelligent agents such that they intuitively and non-intrusively act on a consumer's behalf to obtain information, goods and/or services in a trusted, automated environment, and to methods carried out utilizing the systems. The system architecture is established in such a way that the consumer can be anywhere in the world, and can communicate with a plurality of prospective providers or suppliers of information, goods and/or services through a trusted agent acting as an intermediary on behalf of the consumer. The systems or suite of systems, technologies and processes that form the foundation or frame work of the invention function both passively and interactively, and at all times (i.e. 24/7/365) unless the individual customer turns off any one or more of his or her communication devices.

The system operates on a “trusted” basis meaning that each and every user is protected from being contacted directly by any marketer, seller, provider, distributor, or manufacturer unless the user gives the system authorization to permit such communication.

The basic structure of the system of this invention is made up of a trusted agent which communicates on one side with customer agents (which in turn communicate with customers) and, on the other side, with supplier agents, which in turn communicate directly with their respective suppliers. This communication is carried out by any suitable communication means.

A “provider” or “issuer” is a provider of information of any type such as that related to news, sports, music, products and services.

An “agent” or “sub-custodian” is software code that either runs inside an issuer's network or in the trusted network. Thus agent's as well as to work on behalf of the issuer and to act as a “talker” or broadcaster on the issuer's information to users, consumers and members/subscribers, and a “listener” of information and responses from the users, consumers and members/subscribers.

A “global custodian” acts on behalf of users, consumers, subscribers, members and issuers.

A “member agent”, “user agent” or “customer agent” is software code that works on behalf of an individual user, customer/consumer or member/subscriber.

A “mobile agent” is software code that can run on any JAVA enabled mobile communications device or appliance.

A “PC agent” is software coded but can run on any PC.

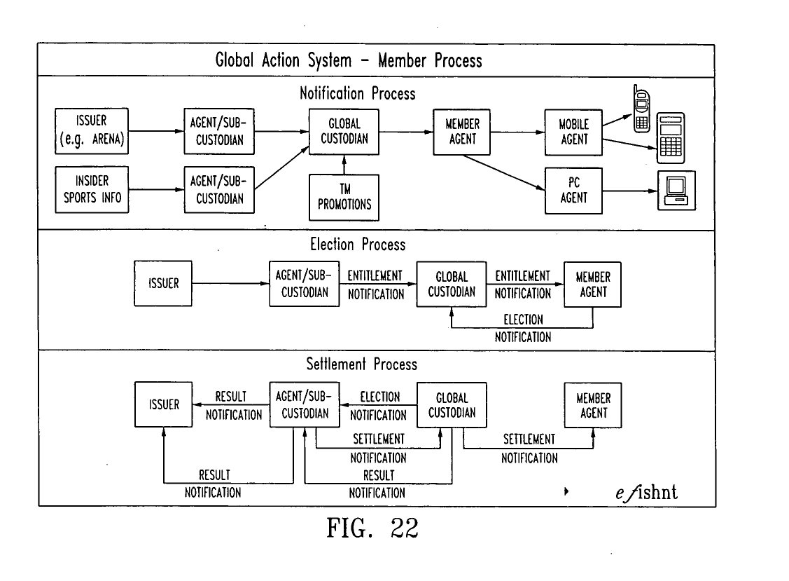

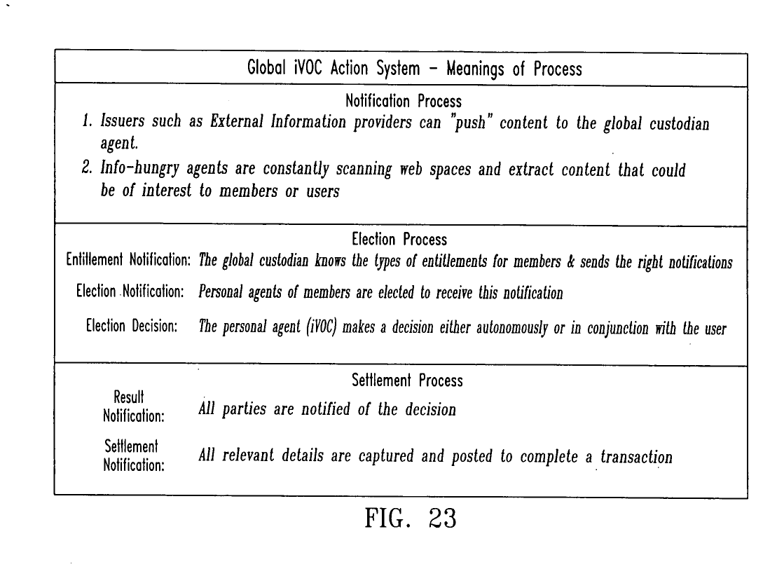

“Notifications” are pieces of information or messages that pass between an issuer, the issuer's agent or sub-custodian, the global custodian, the member agent, the PC or mobile agent and the user or consumer. Types of notifications are entitled “election”, “settlement” and “result”, as shown in FIGS. 22 and 23.

As information users own more communications and mobile computing devices globally, the system of this invention will be able to support their needs around the world, through the automated processing of instruction portfolios that disseminate accurate, real time, personalized information. Among the valuable and unique features of this invention are the posting of end-to-end commercial transactions with zero tolerance for errors and monitoring for receipts in connection with transactions.

By using the systems and methods of this invention, consumers and merchants can effectuate straight through processing, which minimizes bottlenecks from the notification step through to the response step. It enables delivery of notifications in real time due to the immediate processing features of the invention, which does not necessarily require human intervention since the system operates 24/7/365. The distributed delivery aspect of the invention eliminates “middle man” processing and establishes rules based processing to accommodate information distribution to multiple parties concurrently. The system also reduces processing errors because it does not change context from source information prior to provision of responses to users, nor can user responses be misinterpreted because the system utilizes a consistent format end-to-end. The system thinks and acts like each respective user and changes in real time in response to alterations to the user profile databases and actual transaction occurrences.

The user agent is a highly available intuitive assistant which works on behalf of the user, all the time and everywhere delivering the particular kind of information sought at the earliest possible time. Action notifications are delivered immediately, and in some cases via synchronized aggregation which is the process of aggregating information to send to multiple user locations simultaneously. In this way, the system can disseminate information to a multitude of users and/or suppliers having common profiles. By doing so, the system leverages group purchasing power as well.

For example, a user can program in important dates such as birthdays, and also have his or her user agent “shop” for a specific gift and obtain the best deal on that gift based on specified criteria and real time market conditions.

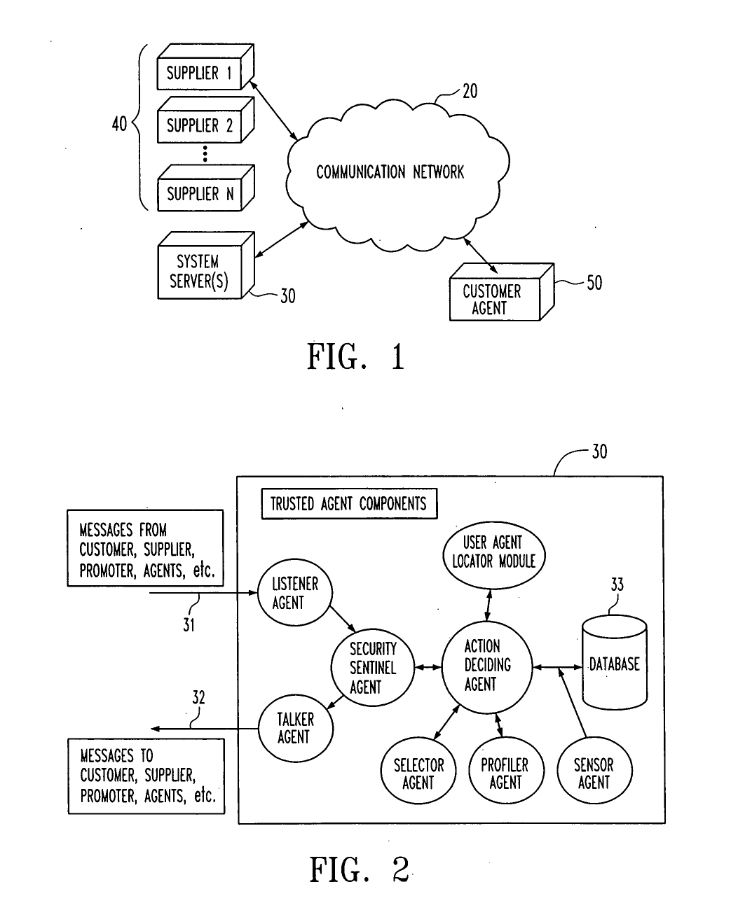

As best seen in FIG. 1, the invention utilizes a communications network 20 which causes communication between a trusted agent/server(s) 30, one or more supplier agents 40, and one or more customer agents 50. The system communicates through any convenient medium such as by wireless or wired communication technology, and need not necessarily be Internet based although communication over the Internet is contemplated to be one of the modes of communication for which at least one aspect of the invention is suited. The communications network 20 may be and/or include any of the systems know today or to be developed in the future.

### I. BROKER AGENT

FIG. 2 is a block diagram of the components of the broker agent wherein the agent is a computer-implemented set of instructions that can reside in any computer device and has the ability to perform a set of predefined operations. The module shown in FIG. 2 has knowledge, intelligence and data. The data is provided both by the customers and by the suppliers, and acted upon by the broker agent. The broker agent 30 can operate with no human intervention at all times. The agent can be configured such that it can reside wholly in one environment or be distributed in more than one environment. By “environment” is meant any computing device or devices such as personal computers, laptops, palm pilots, personal digital assistants (PDAs), navigation systems in motor vehicles, aircraft, marine vessels, etc. The agent 30 is typically configured such that it can receive messages from, and send messages to, supplier or provider agents 40 and customer agents 50. Normally, the supplier/provider agents 40, and the user/customer agents 50, are trusted software agents residing in devices belonging to the suppliers and customers, respectively. However, in the case of suppliers/providers that do not have provider agent software installed in their computer systems, customer interfaces can be created between the listening agent feature of the trusted agent 30 and the supplier's customer relations management (CRM), enterprise resource planning (ERP) or E-commerce systems.

The trusted agent utilizes the following components that perform distinct functions so that the agent as a whole can carry out the purposes of the invention. Each sub component is built using software agent technology and preferably written in Java, although any suitable software language can be employed. In terms of computing design terminology, the trusted agent 30 can be considered made up of a plurality of sub-agents such as the communication devices shown in FIG. 2.

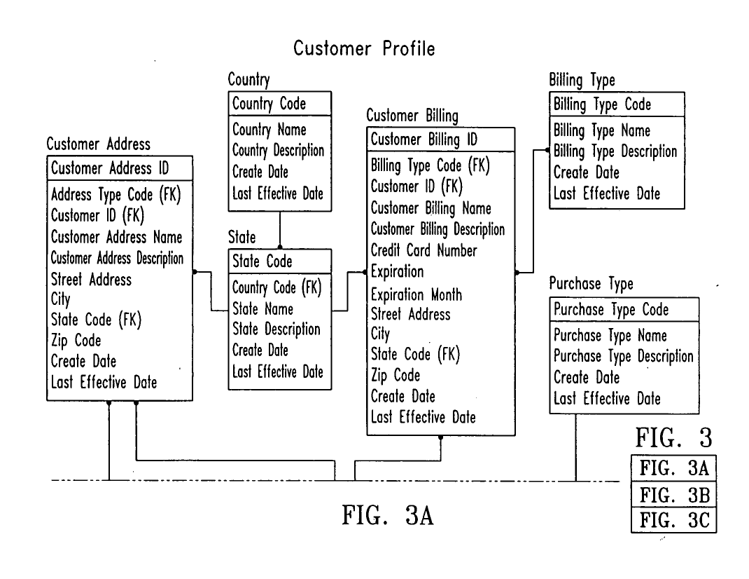

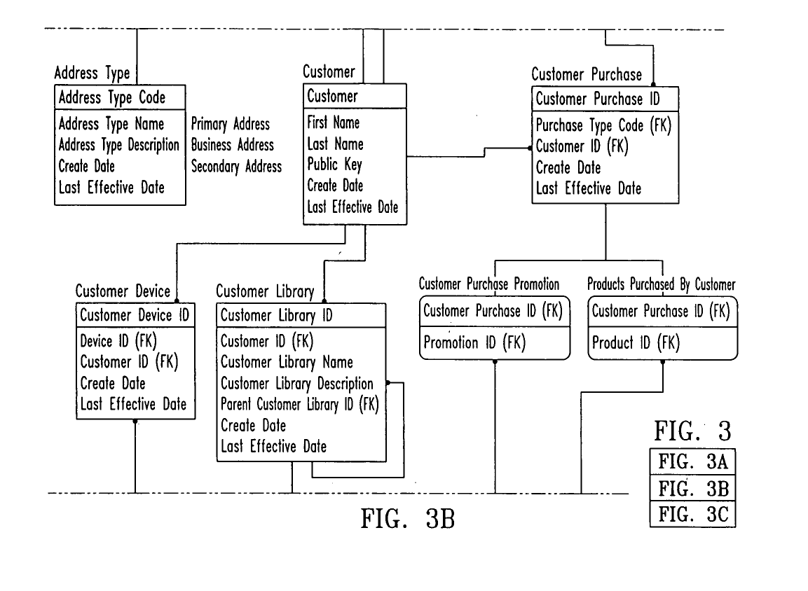

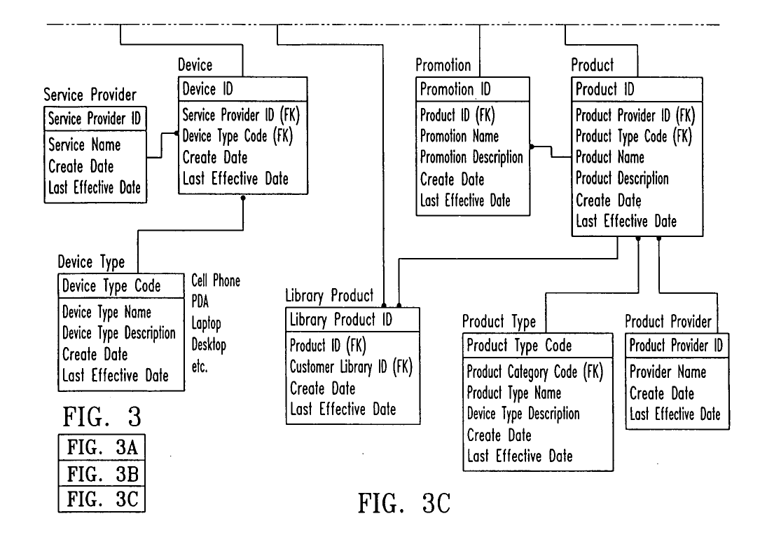

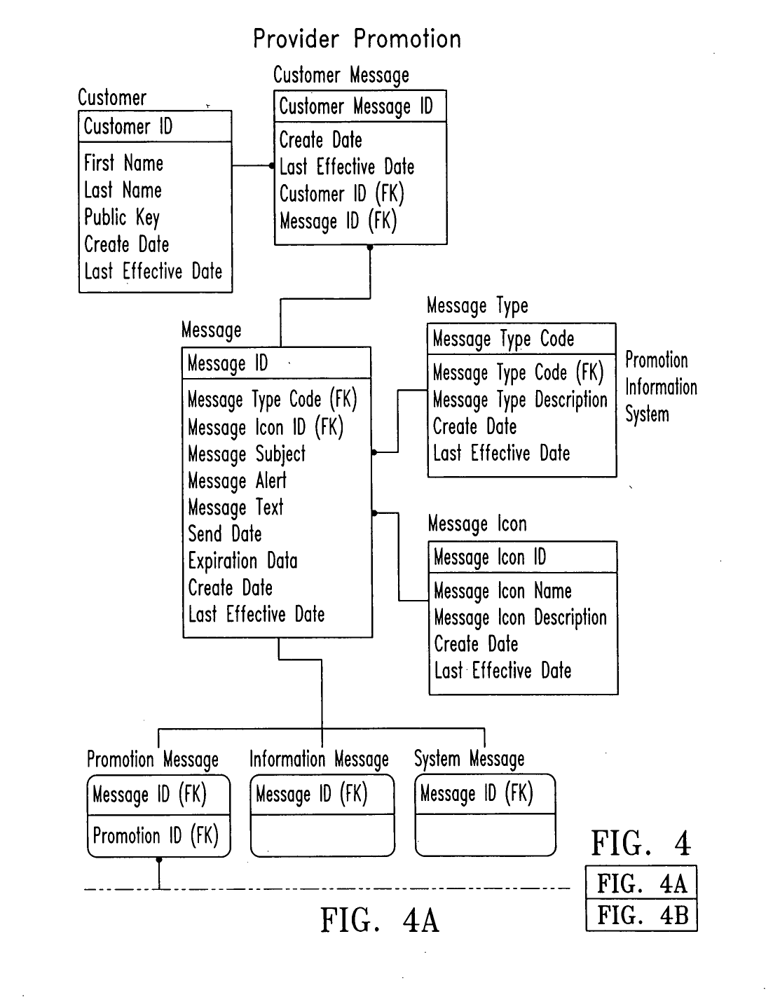

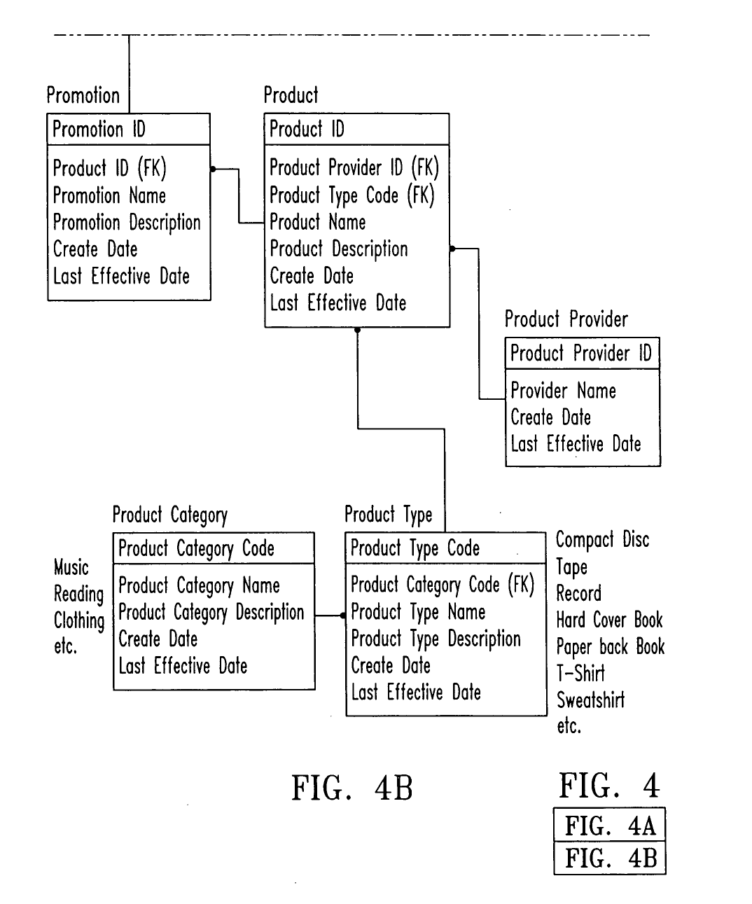

The sensor agent 60 receives messages from the decider agent and meaning of the messages and converts them into a set of optional events in the server, which is the primary logical knowledge (inference table) and data. The data is stored in a relational database. The central database is comprised of primary databases: one for the managing customer messages and profiles and another for managing supplier or provider messages. Messages can be of any kind including multi-media, rich text, video/audio, digital, etc. FIGS. 3 and 4 depict the logical schema for both customer and provider information databases.

### II. CUSTOMER AGENT

The basic atomic structure of the system of this invention made up of a trusted agent which communicates on one side with customer agents (which in turn communicate with customers) and, on the other end, with supplier agents, which in turn communicate directly with their respective suppliers. This communication is carried out by any suitable communication means as discussed previously.

The customer and supplier agents principally will occur in the context of databases which contain all of the individual customer or consumer preferences for goods, information and services, likes and dislikes, moods, decision making style, etc. Also, the trusted agent may itself employ agents to communicate with the supplier agents and the customer agents. Such trusted agents will act on behalf of a single customer agent as well as an aggregation of customer agents (for example, it will know how to reach all customer agents who prefer SUVs and like classical music). A trusted agent's agent also knows the characteristics of supplier agents and can seek out information and discriminate based upon a set of pre-programmed, variable information. In addition, the trusted agent's agents can act as “mining” software but can float in provider systems, constantly looking for material that can be promoted or traded to customer agents. Still further, wallet/money agents can be associated with the trusted agent which can exact or secure a purchase transaction based on pre-programmed criteria or order on behalf of customer agents. Additionally, tracker agents may be associated with the trusted agent which ensures that goods, information and services are supplied in a timely manner to customer agents and supplier agents as well as following up on customer satisfaction.

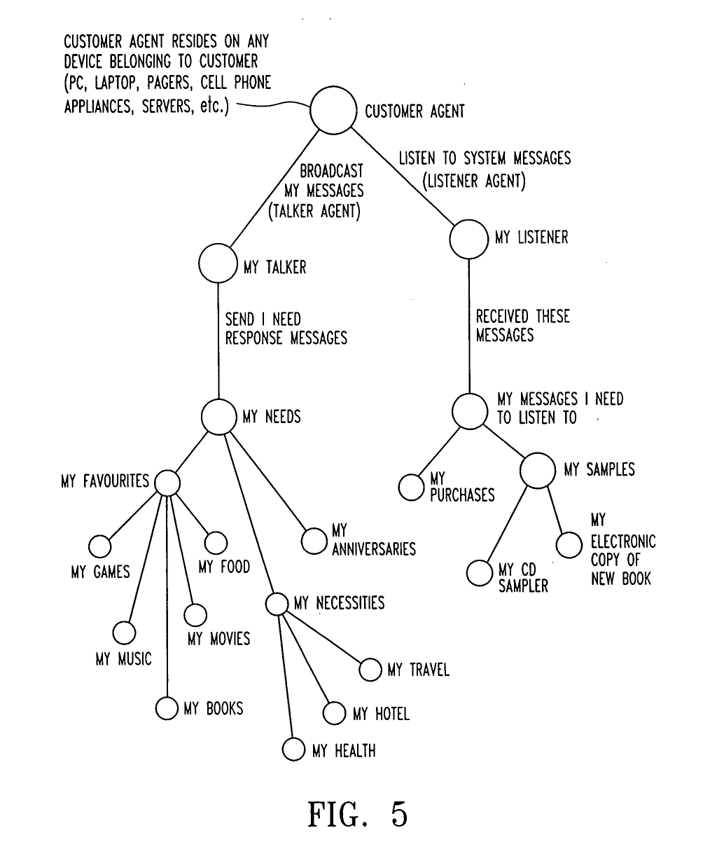

The user agent is a software agent that resides in any number of a multitude of computing devices and JAVA enabled communication devices and appliances, static and mobile. The user agent includes the features shown in FIG. 5. FIG. 5 shows a representative sample of what information a typical user agent will give and receive to and from the broker agent. The user agent can exist in one or more of the customer's devices. Examples of these are television set top boxes, mobile phones, automobile or marine vessel, PDAs, pagers, or personal computers/laptops/notebook computers. Among the novel features of the user agents are the following:
Each customer agent can co-operate with related customer agents to distribute workload. For example, if a message is received on the customer's mobile phone that a free music sampler is available for download on the customer's PC and the customer is on the road, the download process can be triggered on a positive response from the phone. When the download has completed, the customer agent on the PC will send a message to the mobile customer agent saying that it has been completed successfully.
Customer agents can be configured hierarchically so that parent-child relationship exists between mobile customer agents. For example, if a child at home is downloading a game that is only for Mature Adults and the customer (parent) has configured their customer agents to detect such events, a message can be sent to the mobile customer agent saying that this has been done. This watchdog facility may aid in improved parental control and supervision.
The customer agents have learning capability and will adapt over time to understand the customer's tastes and changes in tastes.
The customer agents uses date-triggered events to look ahead and act on behalf of the customer. For example, important dates such as anniversaries, prescription end dates etc.
The customer agent has the unique security key that is used to open message envelopes and to decrypt messages on the customer's devices. This key only resides in permitted devices by the customer.
The customer agent uses a novel symbolic language specially designed to communicate quickly and easily on mobile and portable devices. A toggle facility allows translation from this symbolic language to conventional language on conventional devices such as PCs.
A synchronization facility is built in to allow calendar dates and entries from other calendar/scheduling applications.

The customer agent uses an object database structure that can be customized and changed easily by the customer.

(A.) Customer Agent Object Database Structure

The customer agent objects are tailored to the individual customer. In terms of broad classifications they, at a minimum, fall into these classes:
My Needs (Customer=my)
   My key Dates
   My anniversaries
   My family
   My friends
   My colleagues
My Necessities
   Travel
   Health
   Food
   Finance
My Favorites
   Entertainment
   News
   Sports
   Music
   Books
   Movies
   Theater, etc
Purchases
Samples
Life Style etc.

The customer agents along with the knowledge databases can reside wholly in one device or be distributed as necessary. In the case where they are distributed the use of security keys/encryption ensures that the information on a customer's preferences, likes and tastes do not become visible to either the trusted agent or the supplier agents. This feature enables the trusted agent to act in a trusted and secure manner on behalf of the customer.

### III. SUPPLIER AGENT

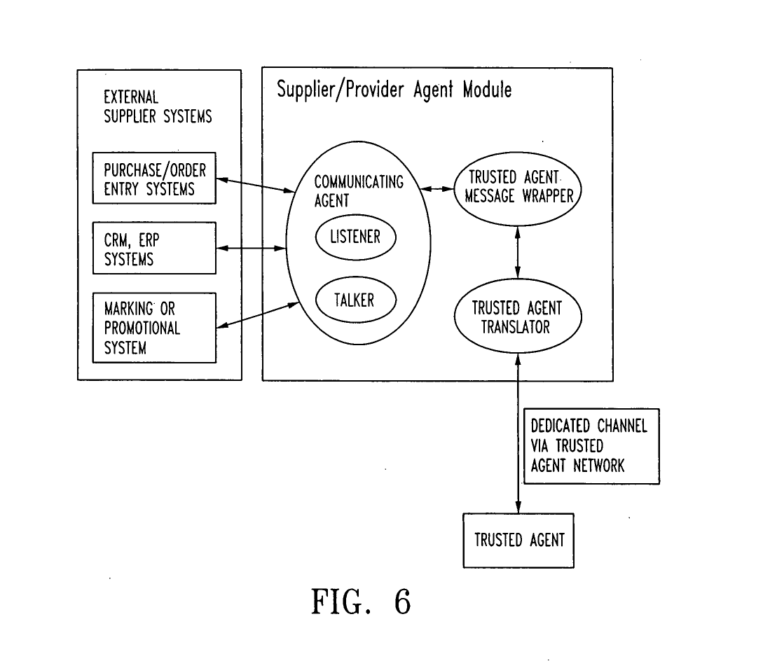

The supplier agent acts on behalf of suppliers. Each supplier will be assigned its own supplier agent with corresponding database information. The supplier is a very general term when used in connection with this invention. A supplier can be a manufacturer, distributor, reseller, advertiser, information provider or promoter. FIG. 6 shows the features and the communication flow of the supplier agent with the supplier on the one hand and the trusted agent on the other. There are three primary functions carried out by the supplier agent:
1. Obtain messages via the listening portal from the supplier systems. Examples of such messages include promotional material such as a special offer on a new CD or music or book reviews in electronic form;
2. Use the message wrapper and translator into a form that can be understood by the system server(s);
3. Send the message to the system server(s) using the system network.

### IV. TRUSTED AGENT NETWORK

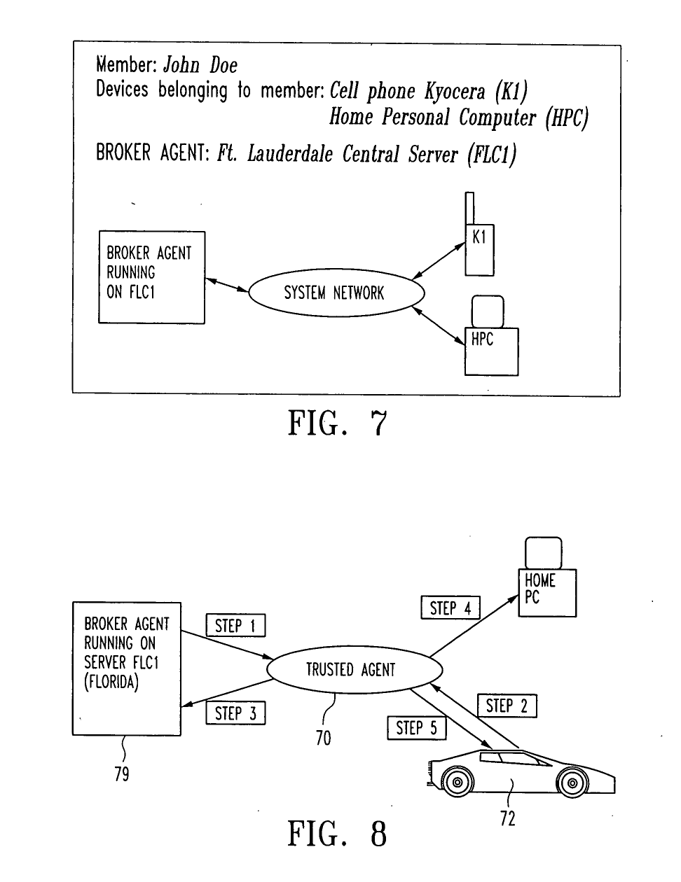

The trusted agent network is a dedicated, intelligent network, which links all members of the overall system. Each member can have one or more devices or appliances in which agents reside and act in response to messages that the various trusted agent, supplier, and customer agents receive. The trusted agent network differs from conventional networks in that the supplier trusted agent and customer agents can be distributed wholly or partially in the network. An example of such an arrangement is shown in FIG. 7.

### EXAMPLE 1

### Case when Customer Terminal (e.g. Java Enabled Cell Phone or Personal Computer) is Unavailable or does not Possess Sufficient Resources to Receive Information

As best seen in FIG. 7 in the normal mode of operation of the system, a message intended for K1 will go to K1 with a copy to HPC for John Doe. K1 will act on the message and send a response to the broker agent on FLC1.

In the case where the network detects that there are not enough resources such as memory for the customer agent in K1 to complete its task, if the PC is not switched on, the network of this system will route the transaction or event/work to be performed by the trusted agent running in the FLC1 trusted agent. Thus, work is always performed to completion.

### VII. EXAMPLE 2

### Case when Cooperating Agents in Different Devices are Used to Complete a Transaction

As shown in FIG. 8, the trusted agent 70 sends a message (step 1) to John Doe's customer agent 72 running on his car Global Positioning System (“GPS”). The message may be “I have a sample of your favorite band's newest album available for free download”. In the next step (step 2) the automobile mounted customer agent responds “yes/okay to receive sampler”. In the next step (step 3) the trusted agent works out which of the customer's other receiver devices (e.g. laptop, PC), etc, is available to receive the information, since the automobile GPS obviously cannot receive an audio download. Next (step 4), the trusted agent network 70 completes the transmission of the sampler to the home PC or other device which the system is informed is/are available. Finally, John Doe's mobile phone can be messaged (step 5) by the trusted agent that the sampler downloaded successfully to John Doe's designated receiving device.

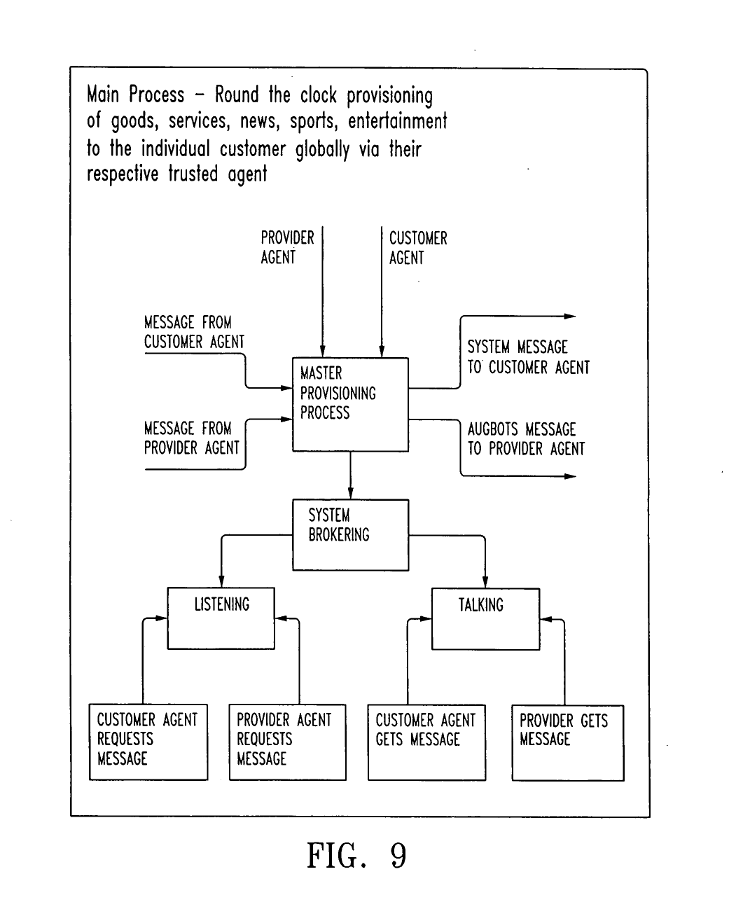

FIG. 9 is a process diagram showing how the main components of the system cooperate. The components are the trusted agent, the supplier agent, the customer agent and the overall system network. Messages are continuously received by the agents running in the components of the system and are acted upon by the intelligent agent within each component and routed to the appropriate collecting agents in both customer and supplier devices.

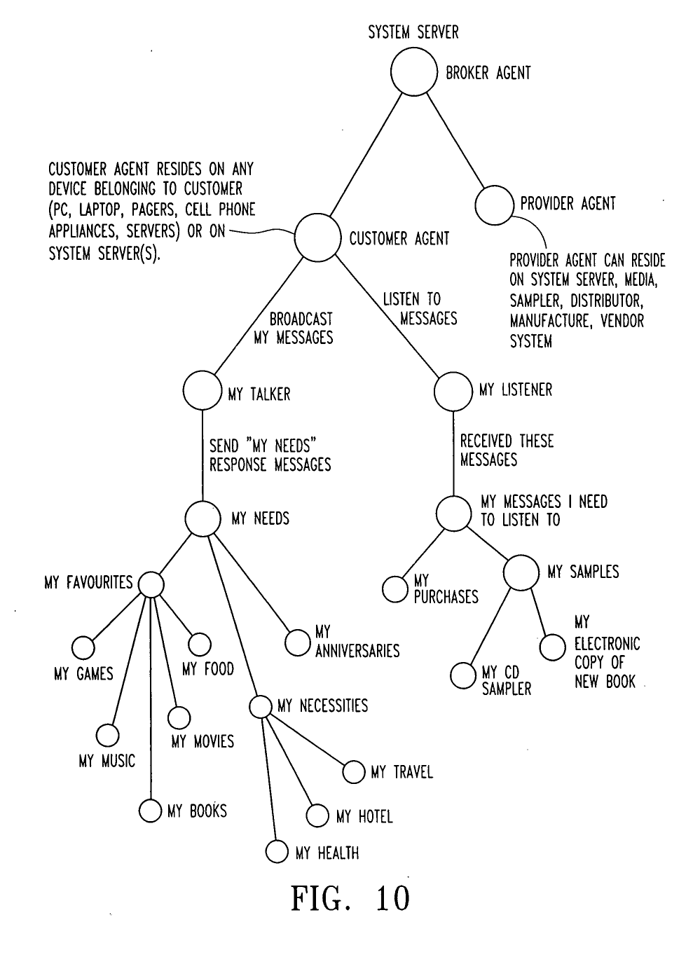

The functionality of the system is shown in FIG. 10, which is an information node tree showing representative categories of information which are passed through the customer agent to or from the customer's communication devices.

### VI. OPERATIONAL DEVELOPMENT OF TRUSTED AGENT AND CUSTOMER/SUPPLIER AGENTS

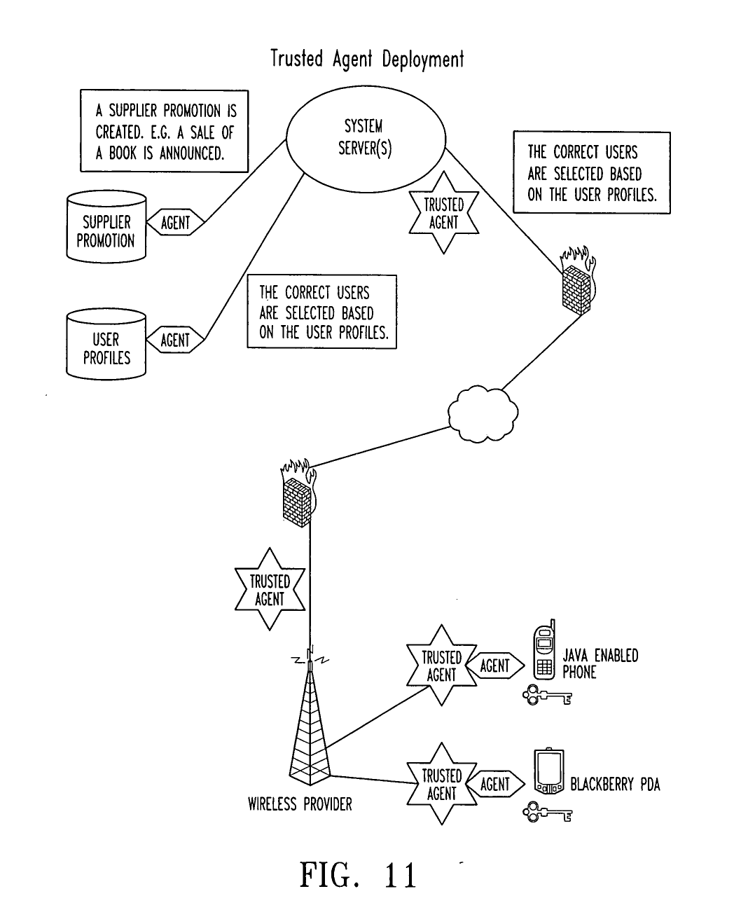

The trusted agent and the respective supplier and customer agents are entirely software components written preferably in the JAVA language. There are also databases and knowledge bases connected to the trusted agent. Preferably but not by way of limitation the trusted agent or series of trusted agents reside in a servi-cluster configuration made up of at least two Unix servers. The customer agents usually reside on a combination of customer devices such as mobile phones, PCs, lap top computers, PDA, such as Palm Pilots, Blackberrys, etc. A typical deployment configuration for the network may include wireless carrier providers as shown in FIG. 11. The trusted agent acts as a message broker to suppliers (providers, promoters, resellers, etc) and customers via their respective devices. The trusted agent or agents is/are used to pinpoint and direct messages and information from suppliers, providers, and promoters to customer devices such as cell phones, portable computing devices such as Palm Pilots, Blackberrys, PCs and JAVA appliances with or without the use of the World Wide Web. In addition trusted agents (i.e. customer agents) can be used to moderate, track, select and procure samples of goods and information of any type including multimedia with or without the use of the World Wide Web. Moreover, the system permits round-the-clock secure commercial transactions to occur between mobile and non-mobile customer computing devices and supplier computer systems, if necessary.

Customer Roll Out

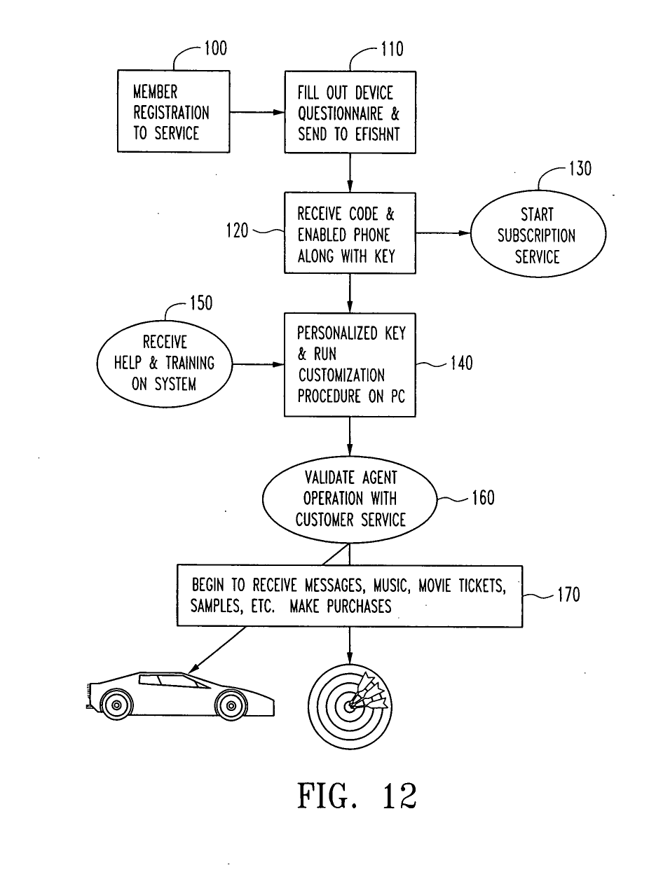

FIG. 12 illustrates the use of the trusted agent, by which potential customers can enroll as members for the associated network. In a first step, prospective members register for the service 100 by filling out a questionnaire preferably online, at step 110. The system receives the information at step 120 and begins the subscription service at 130. A personalized key and customization procedure is installed/run on the customer's PC or other communication device at step 140. The user receives help in the operation and use of the system if necessary at step 150. The system operation is validated for the customer/member at 160, and the customer begins receiving information and in other ways having his or her customer agent act on his or her behalf at step 170.

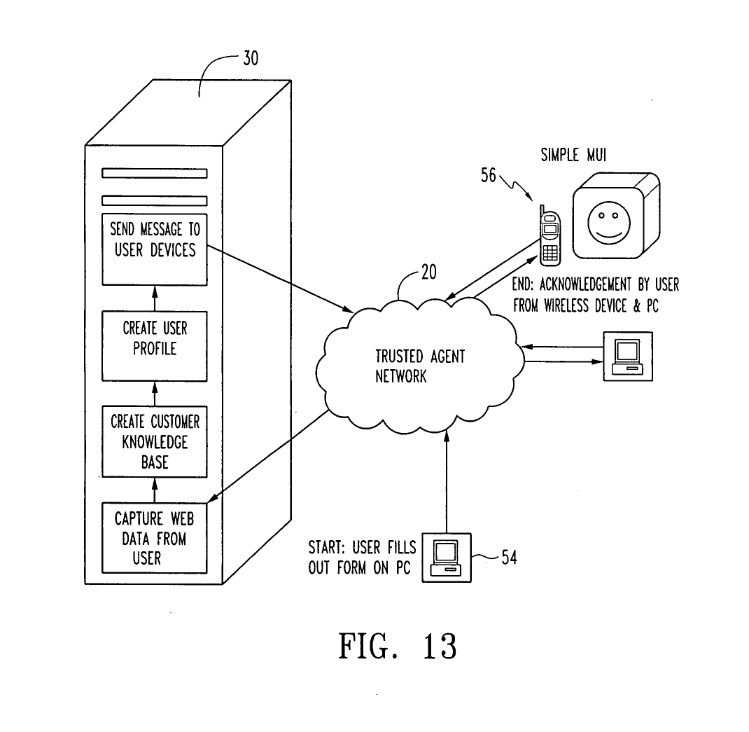

FIG. 13 shows the functional relationships of the user's PC and peripheral devices during the enrollment step. The system server(s) 30 communicates through the trusted agent network 20 with the enrolling party's PC 54 and wireless device 56, and any of the enrolling party's other communication devices, while the enrolling party/prospective user/customer assists the system server 30 in creating an initial knowledge base for that prospective user/customer.

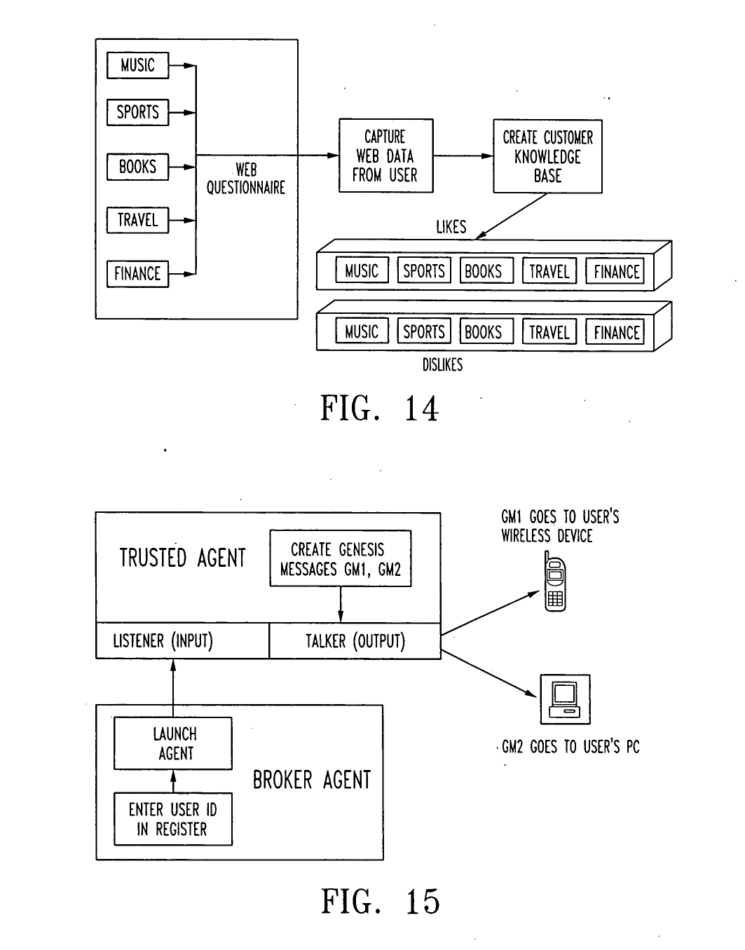

FIG. 14 shows representative knowledge-based categories of the enrollment/customer profile database. However, it is to be understood that additional categories, or fewer categories may be utilized in a particular implementation of the system of this invention.

FIG. 15 indicates the process of communication from the broker agent to the user after enrollment through the user agent, which is sometimes herein referred to as the “trusted agent”. Information is provided by the broker agent specifically and only to the particular user with whom the broker agent is directing a message through that particular user's trusted agent. The information is received by the trusted agent's “listener” agent, which is a software module, and the trusted agent thereafter creates, or generates messages (GM1) and (GM2), which are sent to the user's wireless device and PC, respectively, through a “talker” agent, which is also a software module.

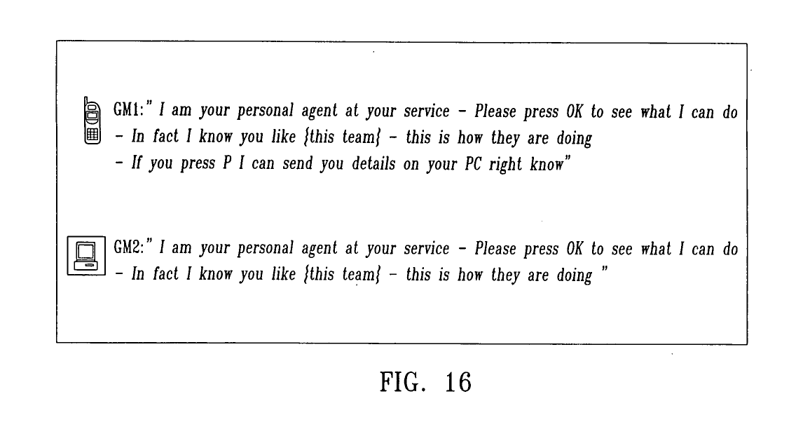

FIG. 16 shows an example of messages which the user agent creates during enrollment and at any time thereafter as new categories of subject matter are introduced.

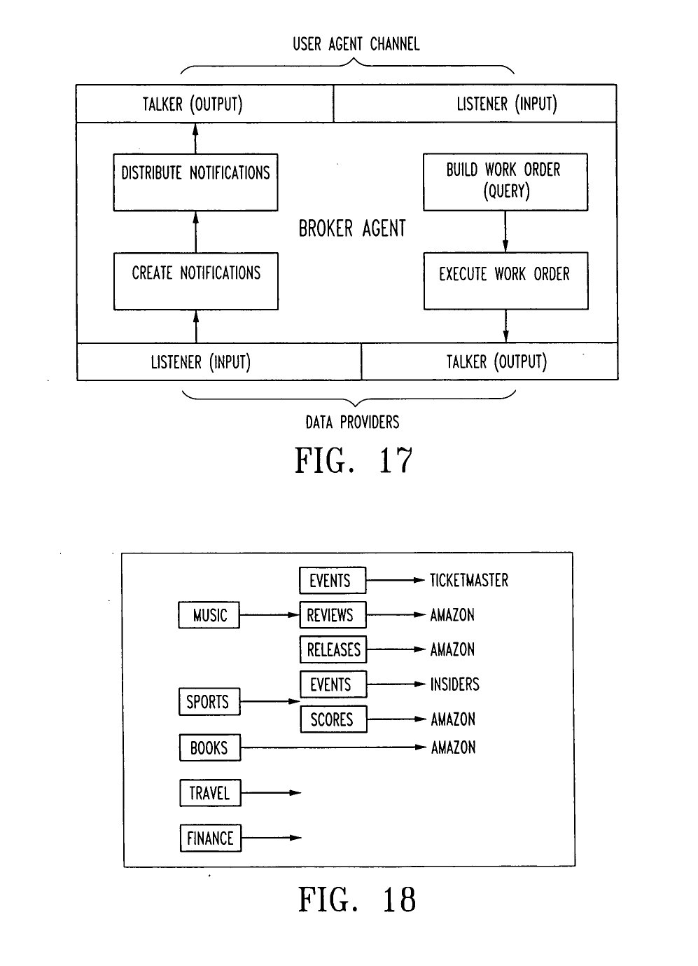

FIG. 17 shows the notifications functions, which are carried out through the trusted agent, in a functional architectural diagram that shows the two primary functions of the broker agent. The first function, the notifications management function, is realized by assigning to the broker agent the task of creating and distributing notifications to either or both the customer and/or supplier agents. The broker agent will create notifications by formatting messages (text and/or symbolic) in a manner that can be understood by the receiver (user agent or supplier agent or both). This function can either be activated by itself, automatically, or by the events, agents, internal or external to the broker agent. The broker agent also distributes notifications by identifying the appropriate receivers and sending notifications to those receivers. This function can also be activated either by itself or by other events, agents, internal of external, to the broker agent. FIG. 17 represents the functional aspects of the trusted/broker agent that include two input channels, one for receiving messages from user agents and one for receiving messages from provider agents, two output channels, one for sending messages to user agents and one for sending messages to provider agents, and a set of core internal functional software components which include managing notifications, managing work orders and managing responses thereto.

Another function of the broker agent is “work order management”. In one aspect, the broker agent will build a work order by building or formatting a set of query instructions that are performed by the “execute work order” function. This function can either be activated by itself or by other events, agent, internal or external to the broker agent. The broker agent also executes work orders. This function will execute one or more work order (queries) typically against external information sources or database. This function, likewise, can either be activated by itself or by other events, agents, internal or external to the broker agent.

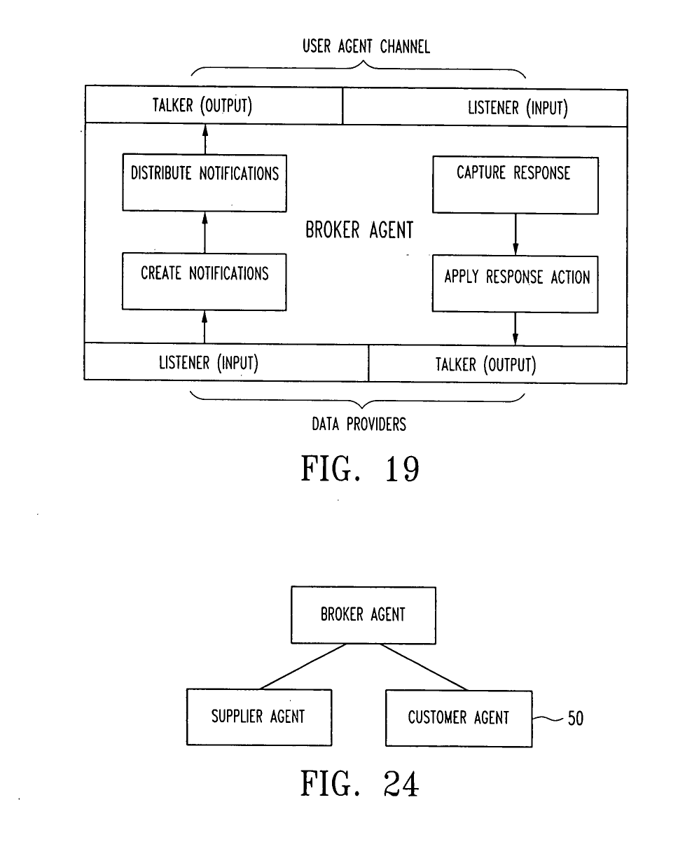

A still further aspect of the broker agent resides in the “capture response” function. This function will capture one or more responses sent by the user agent or the provider agent and pre-process, as shown in FIG. 19, the response in terms of what kind of action to take. This function can either be activated by itself or by events, agents, internal or external to the broker agent. The broker agent also performs an “apply response action” function. This function will complete the necessary work to accomplish a task such as “get 20 tickets for concert event”. This function can also either be activated by itself or by other events, agents, internal or external to the broker agent.

FIG. 18 is a diagrammatic representation of representative data provider sources which the broker agent will have available to it to provide, if appropriate to respective user agents, but not exhaustive, cross section of data providers/issuers.

FIG. 19 shows the flow of information through the trusted agent during the response function processing of the system.

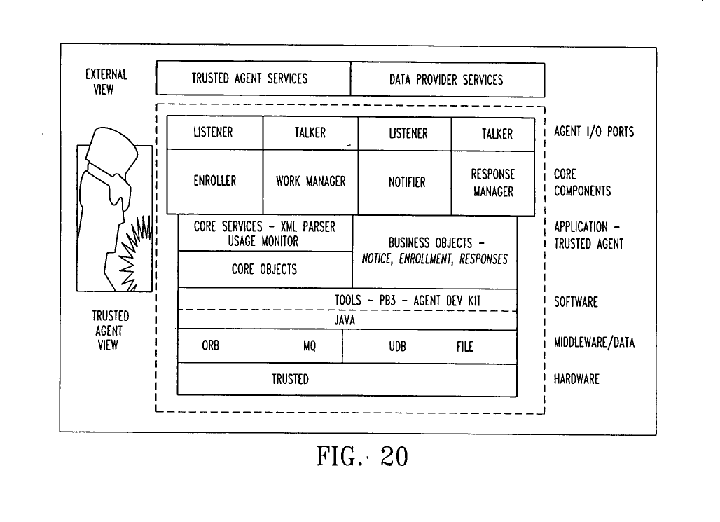

FIG. 20 arrow points to the relationship between the functional components of the trusted agent, which performs work both by itself and on behalf of suppliers and the user agents. It performs trusted services for both parties. The trusted agent is an intelligent agent that performs actions based upon decision criteria and external and information provided to it. The broker/trusted agent has four main functional components:
1. Enroller
2. Work manager
3. Notifier
4. Response manager

The enroller function will enroll a user or a subscriber into the system and will assign a dedicated user agent hat will be owned by that user/subscriber. The work manager will perform work on behalf of one or more user or supplier agents. Functions performed by the work manager can be any function desired of the system. The notifier function will notify, by way of sending messages of any type (text, multimedia, audio, video, etc) to any associated agents (e.g. supplier agents, user agents, etc). The response manager will accept responses from any associated agent and process responses accordingly. These four functional components are communicated to either the user or supplier agents via respective inputs/output ports, which are described as “listener’ and “talker”, respectively. Preferably, the trusted agent is an object-oriented design for tracking or causing services to be performed in the form of, for example, scheduling or creating events, carrying our specific actions, etc. The information utilized b the trusted agent is stored in object/data bases and information provided by the supplier and/or trusted agents.

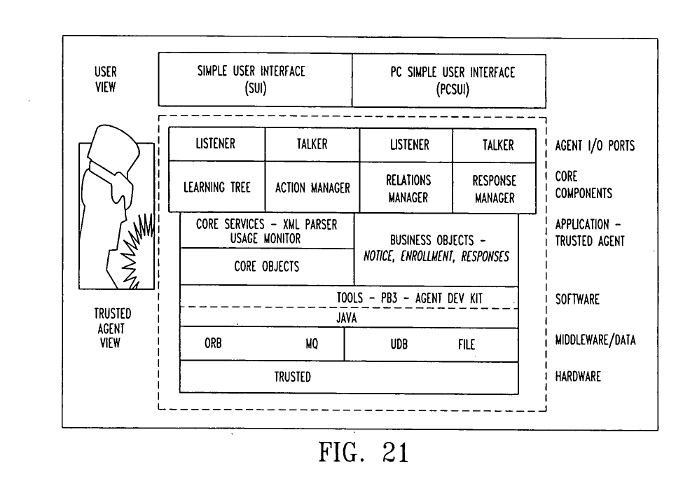

FIG. 21 shows the component architecture of a supplier agent and/or a customer agent. The relationship between the functional components or building blocks of the user agent are shown. This agent performs work both by itself and the user that owns it. This user agent performs trusted services for the owner. The communication devices which permit the user to communicate with his or her user agent can be any suitable device, such as a Java-enabled phone, PC, etc via the respective input/output ports of the agent shown in FIG. 21. The “listener” and “talker” functions operate in the same manner as described in reference to FIG. 20.

There are four main functional components of the user agent:
1. Learning tree
2. Action manager
3. Relations manager
4. Response manager

The learning tree function manages a learning tree that is specific to the user and is adaptive over the course of its lifetime. It learns from repetitive use by the user and by way of meaningful dialogue with the users or related information from other external sources. The action manager performs actions on behalf of the owner or by itself. The relations manager manages relationships with a set of related parties such as a family of user agents or provider agents. The response manager will accept the responses from any associated agent and process responses accordingly.

As in the broker agent, the user agent is based on an object-oriented design adapted to create and carry out actions in the form of services, and utilizes object/knowledge databases. The preferred programming language for the broker agents, user agents and supplier agents is Java.

FIG. 22 is a block diagram that shows the automated actions taken by the trusted agent at 180, 182, 184 and 186, as well as the automated actions taken by the user agent at 201 and 202, as well as the semi-automated actions on the supplier/merchant side.

FIG. 23 shows the agent processing steps, including the mandatory actions taken by the trusted agent, in consummating the procurement of information, goods or services using the system.

FIG. 24 shows that the supplier agents and customer agents communicate with the broker agent, such that suppliers cannot directly contact consumers with communications which the consumers do not wish to receive. The representation shown is by way of example and not by way of limitation. For example, the broker agent will typically be in communication with any number of supplier agents and any number of customer/user agents.

Various modifications and alterations of this invention will become apparent to those skilled in the art without departing from the scope and spirit of this invention, and it is understood that this invention is not limited to the illustrative embodiments set forth hereinbefore

What is claimed is:

1. An information broker for an information distribution system, the information broker comprising:
a memory, the memory storing at least one device characteristic corresponding to at least one user device and at least one characteristic corresponding to a user;
a network interface coupling the information broker to a communication network;
and
a processing unit coupled to the memory and the network interface, the processing unit performing functions including:
receiving a request for information from a first user device;
authenticating the request for information;
providing the information for authenticated requests; and
updating in the memory at least one characteristic corresponding to a user of the first user device based on the request.

2. The information broker according to claim 1, wherein the processing unit further performs the function of using the network interface to transmit an authorization request to a second user, wherein the information is provided if authorization is received from the second user device.

3. The information broker according to claim 2, wherein the processing unit further performs the function of determining a capability of the first user device to receive the requested information based on the at least one device characteristic corresponding to the first user device.
